(19) United States
(12) Patent Application Publication
(10) Pub. No.: US 2004/0143532 A1
(43) Pub. Date: Jul. 22, 2004

(54) Small amount paying/receiving system

(75) Inventor: Raymond Wei Man Lee, Taipei (TW)

Correspondence Address: BACON & THOMAS, PLLC, 625 SLATERS LANE, FOURTH FLOOR, ALEXANDRIA, VA, 22314

(73) Assignee: Fung Chi, LEE, Sai Wan Ho (HK)

(21) Appl. No.: 10/756,252

(22) Filed: Jan. 14, 2004

(30) Foreign Application Priority Data
Jan. 15, 2003 (TW) 92101172

(51) Int. Cl. G06F 17/60

(52) U.S. Cl. 705/35

(57) ABSTRACT

Disclosed is a small amount paying/receiving system for network trading comprises a plurality of pseudo accounts for users to use, each account including a receiving frame and a paying frame for respectively recording the data of the user's depositing, receiving and paying; a money center providing a substantial account corresponding to the respective pseudo accounts to deposit the money for the users; and a message center connecting with the money center. When receiving the message indicating that a first user want to make a trade with a second user and pay for the trade, the message center deducts the amount of the payment from the first user's pseudo account in no time, notifies the second user to provide commodity or service in real time, records the incoming of the payment on the second user's pseudo account after receiving the message indicating the receipt of the trading object from the first user, and notifies the money center to transfer the money from the substantial account to the second user's predetermined bank account after a predetermined period of time.

### BACKGROUND OF THE INVENTION

1. Field of the Invention

The present invention relates a paying/receiving system for on-line transaction, more specifically, to a small amount paying/receiving system for network transaction.

2. Description of the Prior Art

As the developing of Internet is getting broader and broader, more and more goods or services are sold through network. The advantages of network transaction are rapidity and convenience. A buyer may select and buy desired merchandise on a computer at home, without going to the shop. However, for network transaction, payment is an issue worth concern.

The payment for network transaction is usually performed by transferring, remitting or credit card payment. Either transferring or remitting, the service bank will request service fee from the transferrer/remitter. For credit card payment, the credit card center will request a certain rate of the amount as the service fee, for example 3%, from the receiver.

If the amount of the transaction is very small, for example, only NT$10 dollars, then the service fee for transferring or remitting is too much for the buyer; on the other hand, the service fee taken by the credit card center is too much for the seller. If the amount of the transaction is NT$10 dollars, 3% service fee is NTS 0.3, however, the service fee requested by the credit card center is at least NT$1 dollar per transaction. Accordingly, for this transaction, the service fee for credit card payment becomes 10% of the amount, which is much higher than 3%.

In addition, the security of network transaction is another issue worth concern. When a consumer purchases any merchandise a seller via network, the consumer usually needs to pay the bill first, then the seller delivers the merchandise after receiving the payment. Such a transaction mode does not provide sufficient guarantee for the consumer.

Due to the above reasons, network transaction fails to provide sufficient convenience and security, and therefore the development is limited.

A solution for solving the above problems is needed. The present invention satisfies such a need.

### SUMMARY OF THE INVENTION

An objective of the present invention is to provide a network transaction platform. A user can apply for a pseudo account to the platform. The pseudo account comprises receiving frames and paying frames of various currencies for recording the items of receipts and payments. Each frame can be opened or closed as required. Each pseudo account corresponds to a substantial account of a money center of the system in accordance with the present invention. The user can deposit a certain amount of money in the substantial account by ATM transferring, remitting, credit card payment or the like. The amount of the deposited money is registered into the pseudo account. The platform further provides a message center, and when a buying party purchases a commodity and decides to pay, the message center subtracts the amount of the payment from the buying party's pseudo account. In addition, the message center also sends a message to the selling party in real time so as to notify the selling party to complete delivery. After the completion of delivery is confirmed, for example, by receiving the commodity or service, the buying party notifies the message center, then the message center notifies the money center to transfer the amount of payment to the selling party's bank account in a predetermined manner. During the transaction, the message center may registers the incoming of the amount of payment in the selling party's pseudo account after the amount of payment is subtracted from the buying party's pseudo account. Before the amount of payment is practically transferred into the selling party's bank account, the subtracting and transferring done by the message center are only for the account balances of the pseudo accounts, and the real money is still kept in the money center. Accordingly, if any problem occurs during the transaction, the transaction can be suspended at any time.

### BRIEF DESCRIPTION OF THE DRAWINGS

The following drawings are only for illustrating the mutual relationships between the respective portions and are not drawn according to practical dimensions and ratios. In addition, the like reference numbers indicate the similar elements.

FIG. 1 is a schematic diagram showing a small amount paying/receiving system in accordance with the present invention; and

FIG. 2 is a schematic diagram showing a pseudo account in accordance with the present invention.

### DETIALED DESCRIPTION OF THE PREFERRED EMBODIMENT

An embodiment of the present invention will be described in detail with reference to the accompanying drawings.

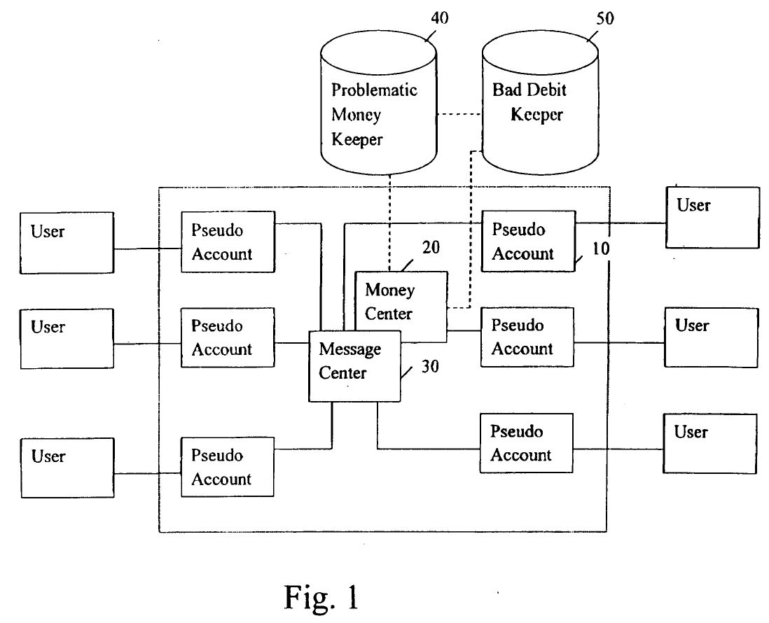

As shown in FIG. 1, a small amount receiving/paying system in accordance with the present invention comprises a plurality of pseudo accounts 10, a money center 20, a message center 30, a problematic money keeper 40, and a bad debit keeper 50.

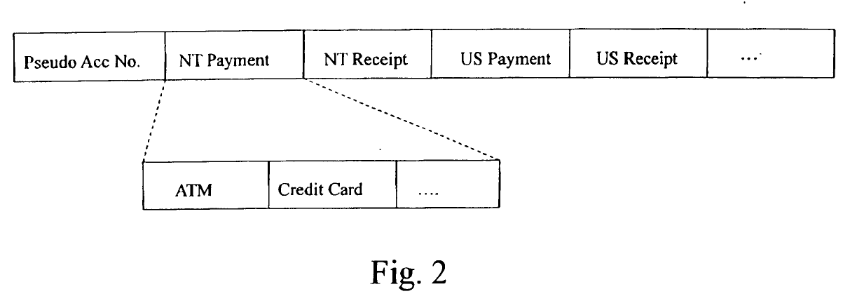

A user can apply for one or more pseudo accounts 10 through a registration process of the system. The user can connect with the system by HTTP and SSL. The pseudo account 10 comprises at least a receipt frame and a payment frame for respectively recording receiving and paying items. If the user only uses the payment frame, the system allows the user to apply for the pseudo account anonymously. If the user selects to use the receipt frame, it is necessary for the user to provide personal information. In addition, the frames can be divided into NT dollar payment frame, NT dollar receipt frame, US dollar payment frame, US dollar receipt frame and the like, so as to be adaptable for transactions of various currencies, as shown in FIG. 2.

In this system, all the practical money flows occur in the money center 20. In operation, the money center 20 can be independent of the system, and managed by a pubic certified organization (e.g. a bank). The money center 20 comprises substantial accounts respectively corresponding to the respective users' pseudo accounts. The substantial account is used to keep the money previously deposited by the user. The user may utilize remitting, transferring or credit card payment to deposit a certain amount of money into the substantial account. The number of the deposited amount is registered on the corresponding pseudo account. The system can set an upper limit for each psudo account, NT$5,000 dollars, for example. When the amount of money deposited into the user's account exceeds the upper limit, the system can deny the deposition or transferring the exceeding portion into the user's predetermined bank account. After the user deposits money into the substantial account, the user can perform payment to any one who joins this system. The user can increase the amount of the pseudo account by transferring, remitting or credit payment, and the increased money is transferred into the corresponding substantial account.

As described above, the system preferably requires that each pseudo account to set a corresponding predetermined bank account. If the user uses the receipt frames, the received money is transferred into the predetermined bank account per predetermined time interval. Alternatively, the received money is transferred into the predetermined bank account whenever the amount of money presented on the receipt frame achieves a predetermined limit. The connection can be established by SSL or VPN. The system provides real time notifications by TEXT, HTML, Socket, XML or SQL etc.

In addition to the Internet, the small amount receiving/paying system in accordance with the present invention can be also applied to mobile phone network. Furthermore, since the messages are transmitted through the message center of the system, the transaction procedure can be performed under the circumstance that the selling party user is not on line.

When the user decides to perform a transaction, the user notifies the message center 30 of the system and authorizes the system to pay. The message center 30 subtracts the amount of payment from the user's pseudo account 10. The message center 30 notifies in no time by email, short message or the like the specified selling party user to provide the commodity or service. At the same time, the message center 30 registers the incoming of the amount of payment into the selling party user's pseudo account. It is noted that only the number presented on the pseudo accounts are increased or decreased at this stage, the practical money is still kept in the money center 20.

The user can previously command the system to pay the selling party at specified time (e.g. a specified date), or pay a certain amount of money to the selling party every predetermined interval (e.g. paying the selling party a fixed amount of money per month).

The system also provides a receivable function, which is adaptable for another transaction mode. A buying party can establish a transaction information on a website other than the system of the present invention, and passes the transaction information to the selling party. The selling party can directly establish a receivable event in this system, and the system will assign an indication code to indicate the event. The selling party notifies the buying party with the indication code of the receivable event by any possible manners, such as email, written letter or the like. Then the buying party can directly pay based on the indication code without re-establish the transaction information. The selling party may apply for a use-once pseudo account, which is not changeable, and provide the same to the buying party to settle the receivable. The use-once pseudo account has a predetermined amount to be deposited. After the buying party uses the use-one pseudo account to transfer the predetermined amount of money into the money center 20, the use-once pseudo account presents the amount of money, and the message center 30 notifies the selling party to provide the commodity or service. The subsequent procedure is the same as described above.

Since the flows of messages and money are performed through different paths, the money center 20 can be managed by a bank, while the message center 30 is managed by the system administrator. Then, only the messages are delivered in the system, and the practical money deposit and withdrawal are done through the money center 20 administered by the bank. Therefore, the security of transaction can be promoted.

The money center 20 keeps the money. The time for the money to be transferred into the selling party user's predetermined bank account can be set as the time that the money center 20 receives a notification from the message center 30 after the buying party receives the commodity or service and notifies the message center 30. Alternatively, it can be set that the money center 20 transfers the money into the selling party user's predetermined bank account at the date after a period of time (e.g. seven days) from the date that the buying party receives the commodity and notifies the message center 20, if no argument happens during this period of time. Before the practical money is transferred to the selling parry user's bank account, the transaction can be suspended at any time. The consumers' rights can be well protected. Every item of the money flow is recorded in the pseudo account. If an argument occurs, the message center 30 notifies the money center 20 to transfer the problematic amount of money to the problematic money keeper 40 for subsequent processing.

In addition, when the buying party user starts to perform a transaction and authorizes the system to pay, the amount of the payment is subtracted from the buying party user's pseudo account, and the money has been previously deposited in the substantial account of the money center 20. Accordingly, the selling party user does not need to worry that the buying party gets the commodity without paying.

In payment of the user, if the user transfers a great amount of money into the substantial account at a time, only one service fee is required. After that, the user performs transactions through the system, no further service fee for transfer is required. If the user deposits a great amount of money into the substantial account by credit card payment, the administrator of the system pays a service fee of a fixed rate to the credit card center. In receipt, the money is transferred into the user's account through the money center 20 of the present system rather than the credit card center, and therefore there is no need to pay the further service fee to the credit card center. The administrator of the system may include the finished transactions in a certain interval or a certain number to totally calculate the service fee according to the credit card service fee calculation mode (e.g. 2%) and charge the selling party user. Accordingly, the selling part user can provide and accept small amount transactions without the problem that the service fee rate is too high as the credit card transaction as mentioned above.

As described above, it is possible to set that the paid money, is kept in the money center 20 for a buffer period before the money is practically transferred into the selling party user's bank account. During the buffer period, if there is any problem, the money is transferred into the problematic money keeper 40. Both parties can determine the ownership of the money by negotiation, arbitration, litigation or the like. For the money remaining in the problematic money keeper 40 due to incorrect account number, suspended account number, bad debit or other reasons, the money is transferred into the bad debit keeper 50 after a certain period of time. It can be set that the money kept in the bad debit keeper 50 is transferred back to the original account that pays the money or belongs to the system after a predetermined period of time (e.g. one year).

The paying and receiving for the transaction are accomplished through the system. The system further has a database (not shown) for recording each transaction item and each user's credit condition, and provides the data for reference. The system may also generate bills based on the transaction data in the database and provide the same to the respective users for reference. The database preferably uses a form that the items can only be added but not modified. Each transaction flow, such as each payment/receipt registration, can be executed by a stored procedure in the system, and cannot not be modified by manual operation. Further, the transaction data can be verified by electronic signature. In addition, the transaction records of the system can be used as statistic data for credit reference, consumption reference, insurance reference or marketing reference. The transaction data of the system can also be used to perform commission distributions.

As mentioned above, each account is set to have an upper limit for deposited money, and can be also set to have a corresponding bank account where money is transferred. The system also provides a dependent pseudo account for the user having a normal pseudo account to apply. The dependent pseudo account can be used by a person other than the user, such as the user's child. The user has the right to suspend the dependent account. Such a concept is similar to the dependent card of credit card.

In the embodiment of the present invention, the system allows the user, who only applies for using the payment frames of the pseudo account, to perform the transaction in an anonymous manner. In addition the system also provides optional classification limit merchandise, such as merchandize availability for buyers older than a certain age, specified regions limit or the like. The system provides an investigation list for classification limits, and presets respective investigation items for the user to select. For each item, the user can determine to maintain the initial settings or modify the settings. When the user intends to perform a transaction with a classification limit, the result of the relative item(s) in the investigation list must meet the requirements of the classification limit for this transaction, then the user is permitted to proceed with this transaction.

While the embodiments of the present invention is illustrated and described, various modifications and alterations can be made by persons skilled in this art. The embodiment of the present invention is therefore described in an illustrative but not restrictive sense. It is intended that the present invention may not be limited to the particular forms as illustrated, and that all modifications and alterations which maintain the spirit and realm of the present invention are within the scope as defined in the appended claims.

What is claimed is:

1. A small amount paying/receiving system for network transaction comprising:
a plurality of pseudo accounts for users to perform transactions, and for recording data of paying and receiving items;
a money center providing a substantial account corresponding to each pseudo account, for storing money deposited by the user; and
a message center subtracting an amount of money from a buying party user's pseudo account and notifying a selling party user to provide a transaction matter, after receiving a message that the buying part user determines to perform the transaction and authorizes to system to pay an amount of money, and notifying the money center to transfer the amount of money into a predetermined bank account set by the selling party user in a predetermined manner, after receiving a message from the buying part, user that the transaction is completed for a predetermined period of time.

2. The system as claimed in claim 1, wherein the pseudo account comprises at least a payment frame and a receiving frame respectively for recording the payment and receipt items, and the system has a function to determine to open or close the payment frame and receiving frame.

3. The system as claimed in claim 2, wherein the payment and receipt frames are respectively divided into frames of various currencies.

4. The system as claimed in claim 1, wherein the pseudo account has an upper limit for deposited money.

5. The system as claimed in claim 4, wherein the user can set a bank account corresponding to the pseudo account, and when the money amount presented on the pseudo exceeds the upper limit, the money center automatically transfers the exceeding portion of the money into the bank account.

6. The system as claimed in claim 4, wherein the money center forbids any money to be deposited into the substantial account if the money amount presented on the pseudo has achieved the upper limit.

7. The system as claimed in claim 1, wherein the user deposits money into the substantial account by remitting, transferring, or credit card payment, and the amount of deposited money is registered on the pseudo account.

8. The system as claimed in claim 1, further comprising a problematic money keeper such that if any problem happens before the amount of money is transferred into the predetermined bank account set by the selling party user, the amount of money is transferred from the money center to the problematic money keeper.

9. The system as claimed in claim 8, further comprising a bad debit keeper such that when the period of time that the amount of money remains in the problematic money keeper exceeds a predetermined period, the amount of money is transferred into the bad debit keeper.

10. The system as claimed in claim 1, wherein the message center adds the amount of money into the selling party user's pseudo account after subtracts said amount of money from the buying party user's pseudo account.

11. The system as claimed in claim 1, further comprising an optional classification limit mechanism such that if the buying party user performs a transaction with classification limit mechanism, the buying party user must obtain the approval of the classification limit mechanism.

12. The system as claimed in claim 1, further comprising a database for recording each payment/receipt item and other information of the transaction.

13. The system as claimed in claim 12, wherein the database has a stored procedure not changeable by manual operation, and each payment/receipt item is recorded through the stored procedure.

14. A small amount paying/receiving system for network transaction comprising:
a plurality of pseudo accounts for users to perform transactions, and for recording data of paying and receiving items;
a money center providing a substantial account corresponding to each pseudo account, for storing money deposited by the user; and
a message center for a selling party user to establish a receivable event, assigning an indication code for the receivable event, the indication code being provided to a buying party user, upon receiving a message indicating that the buying party user authorizes to pay the money for the receivable event, subtracting the amount of the money from the buying party user's pseudo account and notifying the selling party user to provide transaction matter, after receiving the buying party user's message indicating that the transaction is completed, notifying the money center to transfer the amount of money into a predetermined bank account set by the selling party user after a predetermined period of time in a predetermined manner.

15. The system as claimed in claim 14, wherein the pseudo account comprises a use-once pseudo account, which is not changeable, for the selling party user to apply for the buying party user to pay the money.

16. The system as claimed in claim 14, wherein the pseudo account comprises at least a payment frame and a receiving frame respectively for recording the payment and receipt items, and the system has a function to determine to open or close the payment frame and receiving frame.

17. The system as claimed in claim 16, wherein the payment and receipt frames are respectively divided into frames of various currencies.

18. The system as claimed in claim 14, further comprising a problematic money keeper such that if any problem happens before the amount of money is transferred into the predetermined bank account set by the selling party user, the amount of money is transferred from the money center to the problematic money keeper.

19. The system as claimed in claim 18, further comprising a bad debit keeper such that when the period of time that the amount of money remains in the problematic money keeper exceeds a predetermined period, the amount of money is transferred into the bad debit keeper.

20. The system as claimed in claim 14, further comprises an optional classification limit mechanism such that if the buying party user performs a transaction with classification limit mechanism, the buying party user must obtain the approval of the classification limit mechanism.

21. The system as claimed in claim 14, further comprising a database for recording each payment/receipt item and other information of the transaction.

22. The system as claimed in claim 21, wherein the database has a stored procedure not changeable by manual operation, and each payment/receipt item is recorded through the stored procedure.

23. A method for paying/receiving for network transaction, said method comprising steps of:
establishing transaction information for a transaction matter;
obtaining the transaction information;
establishing a receivable event based on the transaction information;
assigning an indication code to the receivable event;
obtaining the indication code; and
paying money of the receivable event with reference to the indication code.

24. The method as claimed in claim 23, further comprising a step of applying for a use-once pseudo account, which is not changeable, for paying the money.
